(19) United States
(12) Patent Application Publication
(10) Pub. No.: US 2024/0199830 A1
(43) Pub. Date: Jun. 20, 2024

(54) Polymer Films

(71) Applicants: Fujifilm Manufacturing Europe B.V., Tilburg (NL); Fujifilm Corporation, Tokyo (JP)

(72) Inventors: Elisa Huerta Martinez, Tilburg (NL); Jacko Hessing, Tilburg (NL)

(21) Appl. No.: 18/282,809

(22) PCT Filed: Mar. 24, 2022
(86) PCT No.: PCT/EP2022/057851

§ 371 Date: Sep. 19, 2023

(30) Foreign Application Priority Data
Mar. 29, 2021 (GB) 2104403.7

(51) Int. Cl. C08J 5/22; B01D 61/44; B01D 61/46; B01D 67/00; B01D 69/02; B01D 71/66; B01J 39/05; B01J 39/20; B01J 47/12; C02F 1/469; C08F 279/02; C08J 5/24; C25B 13/08; H01M 8/1023; H01M 8/1069

(52) U.S. Cl. CPC C08J 5/2243; B01D 61/445; B01D 61/461; B01D 67/0083; B01D 67/009; B01D 69/02; B01D 71/66; B01J 39/05; B01J 39/20; B01J 47/12; C02F 1/4695; C08F 279/02; C08J 5/247; C25B 13/08; H01M 8/1023; H01M 8/1069; B01D 2325/42; C08J 2351/04

(57) ABSTRACT

A polymer film obtainable from curing a composition comprising: (a) a curable ionic compound comprising a bis(sulfonyl)imide group; and (b) a curable non-ionic compound comprising at least 4 vinyl groups.

The present invention relates to compositions suitable for making polymer films, to polymer films, to cation exchange membranes, to bipolar membranes and to their preparation and use.

Ion exchange membranes are used in electrodialysis, reverse electrodialysis, electrolysis, diffusion dialysis and a number of other processes. Typically the transport of ions through the membranes occurs under the influence of a driving force such as an ion concentration gradient or, alternatively, an electrical potential gradient.

Ion exchange membranes are generally categorized as cation exchange membranes or anion exchange membranes, depending on their predominant charge. Cation exchange membranes comprise negatively charged groups that allow the passage of cations but reject anions, while anion exchange membranes comprise positively charged groups that allow the passage of anions but reject cations. Bipolar membranes have both a cationic layer and an anionic layer.

Some ion exchange membranes and bipolar membranes comprise a porous support which provides mechanical strength. Such membranes are often called “composite membranes” due to the presence of both an ionically-charged polymer which discriminates between oppositely charged ions and the porous support which provides mechanical strength.

Cation exchange membranes may be used for the treatment of aqueous solutions and other polar liquids, and for the generation of electricity.

Bipolar membranes may be used for the production of acids and bases from salt solutions e.g. for the recovery of hydrofluoric acid and nitric acid, for the separation and treatment of organic acids such as lactic acid and citric acid and for producing amino acids.

Electricity may be generated using reverse electrodialysis (RED) in which process standard ion exchange membranes or bipolar membranes may be used. Cation exchange membranes may also be used for the generation of hydrogen, e.g. in fuel cells and batteries.

Bipolar membranes can be prepared by many different methods. In U.S. Pat. Nos. 4,024,043 and 4,057,481 (both Dege et al.) single-film bipolar membranes are prepared from pre-swollen films containing a relatively large amount of an insoluble, cross-linked aromatic polymer on which highly dissociable cationic exchange groups are chemically bonded to the aromatic nuclei to a desired depth of the film from one side only; subsequently, highly dissociable anionic exchange groups are chemically bonded to the unreacted aromatic nuclei on the other side of the film.

In Japanese patent publication Nos. 78-158638 and 79-7196 (both Tokuyama Soda Co. Ltd.), bipolar membranes are prepared by partially covering a membrane with a cover film, sulphonating the surface of the membrane not in contact with the cover film to introduce cation exchange groups, exfoliating the cover film and introducing anion exchange groups on the exfoliated surface.

Bipolar membranes have also been prepared by bonding together an anion exchange film or membrane and a cation exchange film or membrane. The two monopolar membranes of opposite selectivity can be fused together by the application of heat and pressure to form a bipolar membrane. See, for example U.S. Pat. No. 3,372,101 to Kollsman wherein separate cation and anion membranes are bonded together in a hydraulic press at 150° C. at a pressure of 400 lb/sq. inch to form a two-ply bipolar membrane structure. However, bipolar membranes formed in this way suffer the disadvantage of high electrical resistance produced by their fusion. Furthermore these membranes are prone to bubble or blister and they are operable for only short time periods at relatively low current densities.

The abovementioned disadvantages make the known bipolar membranes unattractive for commercial electrodialysis operations.

According a first aspect of the present invention there is provided a polymer film obtainable from curing a composition comprising:
(a) a curable ionic compound comprising a bis(sulfonyl)imide group; and
(b) a curable non-ionic compound comprising at least 4 vinyl groups.

In this specification the term “comprising” is to be interpreted as specifying the presence of the stated parts, steps or components, but does not exclude the presence of one or more additional parts, steps or components.

Reference to an element by the indefinite article “a” or “an” does not exclude the possibility that more than one of the element(s) is present, unless the context clearly requires that there be one and only one of the elements. The indefinite article “a” or “an” thus usually means “at least one”.

Vinyl groups are of the formula —CH═CH_{2.}

The curable non-ionic compound comprising at least 4 vinyl groups is preferably a non-ionic linear oligomer or polymer comprising a backbone chain and at least 4 vinyl groups attached to the backbone chain. Preferably the curable non-ionic compound comprises at least 5 vinyl groups, more preferably at least 8 vinyl groups attached to the backbone chain. Preferably the vinyl groups are non-acrylic, i.e. the vinyl groups are not attached to (C═O)O-groups or (C═O)NH-groups.

Preferably component (b) comprises from 4 to 75 vinyl groups, more preferably 5 to 60 vinyl groups, especially 10 to 60 vinyl groups and more especially 12 to 55 vinyl groups.

Preferably component (b) has a molecular weight (Mn) of at least 600 g/mol, more preferably at least 1,000 g/mol.

Preferably component (b) is a curable non-ionic compound of Formula (I):

R′—Aₙ—Bₘ—C_{q}—R′ Formula (I)
wherein:
A is [CH₂CH═CHCH₂];
B is [CH₂CH(CH═CH₂)];
C is [CH₂CH(C₆H₅)];
n has a value of from 5 to 85% of the sum of (n+m+q);
m has a value of from 15 to 95% of the sum of (n+m+q);
q has a value of from 0 to 30% of the sum of (n+m+q); and
each R′ independently is H or OH;
provided that the non-ionic compound of Formula (I) comprises at least 4 vinyl groups.

In Formula (I) groups represented by A are each independently in the cis or the trans configuration.

Preferably the curable non-ionic crosslinking agent of Formula (I) is a random, linear copolymer. The groups shown in brackets in Formula (I) (i.e. [CH₂CH═CHCH₂]ₙ, [CH₂CH(CH═CH₂)]ₘ and [CH₂CH(C₆H₅)]_{q}) are preferably distributed randomly in Formula (I). Thus the groups shown in brackets in Formula (I) are preferably not in the form of continuous blocks and the curable non-ionic crosslinking agent of Formula (I) is preferably not in the form of a diblock or triblock copolymer.

Groups A and B in Formula (I) represent butadiene-derived groups, i.e. component (b) may be obtained by a process comprising polymerisation of a composition comprising butadiene monomers (and optionally styrene monomers, the latter being represented by group C in Formula (I)).

Preferably component (b) comprises at least 8 groups derived from group B, more preferably at least 10 groups derived from group B.

In a preferred embodiment, component (a) is selected from curable compounds of Formula (II):

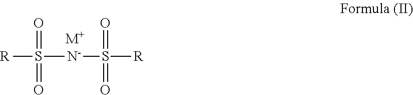

wherein:
each R independently comprises a polymerisable or non-polymerisable group; and
M⁺ is a cation.

In order to ensure that the component (a) is curable, it is preferred that the compound of Formula (II) comprises at least two polymerisable groups.

Preferred non-polymerisable groups include alkyl (especially C₁₋₆ alkyl) and C₆-C₁₈ aryl (especially phenyl or naphthyl), each of which is unsubstituted or carries one or more non-polymerisable substituents, e.g. C₁₋₄-alkyl, C₁₋₄-alkoxy, sulpho, carboxy, or hydroxyl group.

Preferred polymerisable groups which are present in component (a) are reactive with component (b), e.g., reactive with the vinyl groups present in component (b).

Preferred polymerisable groups comprise ethylenically unsaturated groups, or thiol groups (e.g. alkylenethiol, preferably —C₁₋₃—SH). Optionally the polymerisable groups further comprise an optionally substituted alkylene group (e.g. optionally substituted C₁₋₆-alkylene) and/or an optionally substituted arylene group (e.g. optionally substituted C₆₋₁₈-arylene). The preferred substituents, when present, include C₁₋₄-alkyl, C₁₋₄-alkoxy, sulpho, carboxy, and hydroxyl groups.

Preferred ethylenically unsaturated groups include vinyl groups, (meth)acrylic groups (e.g. CH₂═CR¹—C(O)— groups), especially (meth)acrylate groups (e.g. CH₂—CR¹—C(O)O— groups) and (meth)acrylamide groups (e.g. CH₂═CR¹—C(O)NR¹— groups), wherein each R¹ independently is H or CH₃). Most preferred ethylenically unsaturated groups comprise or are vinyl groups, for example allyl groups.

Each M⁺ independently is preferably an ammonium cation or an alkali metal cation, especially Li⁺. When M⁺ is Li⁺ the resultant compounds have particularly good solubility in water and aqueous liquids.

Preferably component (a) is of Formula (III):

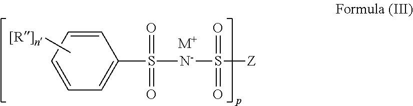

wherein:
each R″ independently is a polymerisable or non-polymerisable group;
n′ has a value of 1 or 2;
p has a value of 1, 2 or 3;
M⁺ is a cation; and
Z is N or a linking group;

provided that the compound of Formula (III) comprises at least two polymerisable groups.

When R″ is a polymerisable group R″ is preferably an ethylenically unsaturated group or a thiol group (e.g. alkylenethiol, preferably —C₁₋₃—SH). Most preferred ethylenically unsaturated groups comprise or are vinyl groups, for example allyl groups. Optionally the polymerisable groups further comprise an optionally substituted alkylene group (e.g. optionally substituted C₁₋₆-alkylene) and/or an optionally substituted arylene group (e.g. optionally substituted C₆₋₁₈-arylene). The preferred substituents, when present, include C₁₋₄-alkyl, C₁₋₄-alkoxy, sulpho, carboxy, and hydroxyl groups. When R″ is a non-polymerisable group R″ is preferably alkyl (especially C₁₋₆ alkyl) or C₆-C₁₈ aryl (especially phenyl or naphthyl), each of which is unsubstituted or carries one or more non-polymerisable substituents, e.g. C₁₋₄-alkyl, C₁₋₄-alkoxy, sulpho, carboxy, or hydroxyl group. R″ is a preferably a polymerisable group.

M⁺ is preferably an ammonium cation or an alkali metal cation, especially Li⁺.

In a preferred embodiment, component (a) is of Formula (III) wherein p and n′ both have a value of 1, Z is a phenylene group carrying a vinyl group and R″ and M⁺ are as hereinbefore defined.

In another preferred embodiment, component (a) is of Formula (III) wherein p has a value of 2 or 3, Z is a C₁₋₆-alkylene, C₁₋₆ perfluoroalkylene or C₆₋₁₈-arylene group or Z is a group of the formula N(R″′)₍₃₋ₚ₎ wherein each R′″ independently is H or C₁₋₄-alkyl and R″ and M⁺ are as hereinbefore defined.

In a preferred embodiment, component (a) is of Formula (III) wherein p has a value of 1, n′ has a value of 2, Z is a C₁₋₆-alkyl, C₁₋₆-perfluoroalkyl or C₆₋₁₈-aryl group or a group of the formula N(R′″)₂ wherein each R′″ independently is H or C₁₋₄-alkyl and R″ and M⁺ are as hereinbefore defined.

Furthermore, many of the compounds of component (a) may be prepared by a process comprising the steps of:
(i) providing a benzenesulfonyl chloride compound;
(ii) reacting the sulfonyl chloride group of component (i) with a compound comprising a sulfonamide group to obtain the compound of Formula (II) or Formula (III);
wherein at least one of component (i) and component (ii) comprises at least one polymerisable group or a precursor thereof, preferably a vinyl group or thiol group.

Typically the vinyl group or thiol group is attached to a benzene ring of component (i) and/or (if present) of component (ii). In a preferred embodiment the benzenesulfonyl chloride compound used in the process comprises one or more vinyl groups, more preferably one or two vinyl groups.

Component (b) is a non-ionic compound and therefore is free from ionic groups, e.g. free from sulphonic acid and sulphonate groups.

The values of n, m and q define the proportion, numerically, of each of the groups A, B and C respectively in the compound of Formula (I) relative to the total amount of the groups A, B and C (i.e. n+m+q)) in the compound of Formula (I).

Preferably n has a value 5% to 85%, more preferably 5% to 80%, especially 10% to 75% and more especially 15% to 72% of the sum of (n+m+q).

Preferably m has a value 15% to 95%, more preferably 20% to 95%, especially 25% to 90% and more especially 28% to 85% of the sum of (n+m+q).

Preferably q has a value 0 to 30% of the sum of (n+m+q).

The values of n, m and q are therefore number % relative to the total number of (n+m+q) groups.

Preferably (n+m+q) has an absolute value of 5 to 270, more preferably 10 to 155, especially 10 to 145, more especially 19 to 130. In absolute terms, preferably m has a value of 5 to 75, more preferably 6 to 70, especially 8 to 60. In absolute terms, preferably n has a value of 1 to 150, more preferably 2 to 120, especially 2 to 110.

In absolute terms, preferably q has a value of 0 to 80, more preferably 0 to 50, especially 0 to 40.

In a preferred embodiment, component (b) is of the Formula (IV):

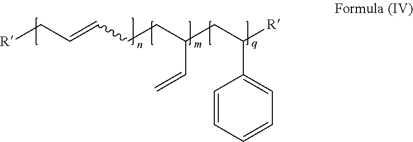

wherein n, m, q and each R′ independently are as hereinbefore defined and preferred.

Preferably the number of vinyl groups in the curable non-ionic compound (component (b)) is at least 10 and especially at least 12.

Optionally, component (b) comprises styrene groups. Such styrene groups are preferably distributed randomly within component (b).

Examples of component (b) include polybutadiene polymers (especially through predominantly 1,2-addition), styrene-butadiene copolymers (especially through predominantly 1,2-addition) such polymers carrying one or more (especially two) OH groups, provided that such polymers comprise at least 4 vinyl groups. Such materials can be obtained from commercial sources, e.g. from Cray Valley Technologies, Nippon Soda Co, Ltd.

Component (b) preferably has a melting point below 50° C., more preferably below 40° C., especially below 30° C. Component (b) preferably has a viscosity not higher than 600 Poise, more preferably less than 400 Poise, especially lower than 200 Poise, more especially below 100 Poise, when measured at 50° C. or 40° C. by a suitable viscosity meter such as a Brookfield viscosity meter. When component (b) has this preferred melting point and/or viscosity then manufacturing of the polymer film is facilitated.

The polymer films of the present invention have particularly good flexibility. As a consequence, the polymer film typically has low brittleness, a low tendency to form cracks and can be used in applications requiring high pressures, e.g. in fuel cells.

Preferably component (b) has a Mn not higher than 15,000 Da more preferably lower than 8,000 Da. Preferably component (b) comprises up to 260 butadiene-derived groups, more preferably up to 140 butadiene-derived groups. Examples of commercially available, curable non-ionic compounds of Formula (I) which may be used as component (b) are listed in the following table:

In Table 1 m indicates the number % of vinyl groups corresponding to group B, n indicates the number % of in-chain double bonds corresponding to group A and q indicates the number % of styrene derived groups corresponding to group C in Formula (I).

TABLE 1
Commercially available examples of component (b)

| | | | | | n* | | q* | vinyl |
|---|---|---|---|---|---|---|---|---|
| | | | | | (in-chain | m* | (styrene- | groups |
| | Commercial | | MW* | Viscosity* | double | (vinyl | derived | per |
| | name | R′* | (g/mol) | (Poise) | bonds) | groups) | groups) | chain* |
| 1 | Polybutadiene, | H | n.s. | 30-100 | 10% | 90% | 0% | n.s. |
| | predominantly | | | | | | | |
| | 1,2-addtion | | | | | | | |
| 2 | Ricon ® 130 CF | H | 2500 | 7.5 | 72% | 28% | 0% | 14 |
| 3 | Ricon ® 131 | H | 4500 | 27.5 | 72% | 28% | 0% | 23 |
| 4 | Ricon ® 134 | H | 8000 | 150 | 72% | 28% | 0% | 41 |
| 5 | Ricon ® 142 | H | 3900 | 97.5 | 45% | 55% | 0% | 40 |
| 6 | Ricon ® 152 | H | 2900 | 200 | 20% | 80% | 0% | 43 |
| 7 | Ricon ® 156 | H | 1400 | 16 | 30% | 70% | 0% | 23 |
| 8 | Ricon ® 157 | H | 1800 | 60 | 30% | 70% | 0% | 23 |
| 9 | Krasol ® LBH | OH | 2100 | 130 | 35% | 65% | 0% | 22 |
| | 2000 | | | | | | | |
| 10 | Krasol ® LBH-P | OH | 2100 | 130 | 35% | 65% | 0% | 22 |
| | 2000 CF | | | | | | | |
| 11 | Krasol ® LBH | OH | 3000 | 200 | 35% | 65% | 0% | 34 |
| | 3000 | | | | | | | |
| 12 | Krasol ® LBH-P | OH | 3200 | 200 | 35% | 65% | 0% | 34 |
| | 3000 CF | | | | | | | |
| 13 | Poly bd ® R45 | OH | 2800 | 50 | 80% | 20% | 0% | 10 |
| | HTLO | | | | | | | |
| 14 | Ricon ® 300 | H | 2000 | 15 | 85% | 15% | 0% | 5 |
| 15 | Ricon ® 100 | H | 4500 | 400 | 5% | 70% | 25% | 54 |
| 16 | Ricon ® 181 | H | 3200 | 175 | 42% | 30% | 28% | 17 |
| 17 | Nisso-PB | H | 1200 | >10 | 15% | 85% | 0% | n.s. |
| | B-1000 | | | | | | | |
| 18 | Nisso-PB | H | 2100 | >65 | 10% | 90% | 0% | n.s |
| | B-2000 | | | | | | | |

Compound 1 is from Sigma Aldrich, compounds 2 to 16 are from Cray Valley and 17 + 18 are from Nippon Soda Co.
*the data are derived from the corresponding supplier.
n.s. means ‘not specified by the supplier’.

Preferably component (a) is copolymerisable with component (b). For example:
component (a) and component (b) both comprise one or more ethylenically unsaturated groups; or
component (a) comprises thiol groups and the double bonds shown in component (b) are reactive with thiol groups of component (a).

When the composition comprising components (a) and (b) is cured, typically most of components (a) and (b) are copolymerised. However small amounts of components (a) and (b) may remain unreacted in the polymer film even after curing.

The polymer film according to the first aspect of the present invention is preferably obtainable by curing a composition comprising:
(a) component (a) as defined above;
(b) component (b) as defined above;
optionally (c) a compound comprising one and only one polymerisable group;
optionally (d) one or more radical initiators; and
optionally (e) solvent.

Preferably the composition comprises one, two or all three of components (c), (d) and (e). The abovementioned composition forms a second aspect of the present invention.

Preferably, in some embodiments, the composition comprises 20 to 80 wt %, more preferably 30 to 60 wt %, of component (a).

Preferably the composition comprises 0.5 to 20 wt %, more preferably 1 to 18 wt %, most preferably 1 to 16 wt %, of component (b).

Preferably the composition comprises 0 to 40 wt %, more preferably 5 to 30% wt %, most preferably 6 to 25 wt %, of component (c).

Preferably the composition comprises 0 to 10 wt %, more preferably 0.001 to 5 wt %, most preferably 0.005 to 2 wt %, of component (d).

Preferably the composition comprises 0 to 40 wt %, more preferably 15 to 40 wt %, most preferably 20 to 30 wt %, of component (e).

The preferred ethylenically unsaturated group which may be present in component (c) is as defined above in relation to R, e.g. a vinyl group, e.g. in the form of allylic or styrenic group. Styrenic groups (also called “styrene-derived groups” in this specification) are preferred over e.g. (meth)acrylic groups as they increase the pH stability of the polymer films across the range of pH 0 to 14, which is of special interest to bipolar membranes and cation exchange membranes for fuel cells.

Examples of compounds which may be used as component (c) of the composition include the following compounds of Formula (MB-α), (AM-B) and Formula (V):

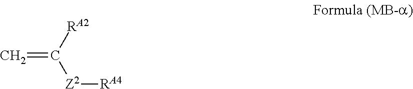

wherein in Formula (MB-α),
R^{A2} represents a hydrogen atom or an alkyl group,
R^{A4} represents an organic group comprising a sulfo group in free acid or salt form and having no ethylenically unsaturated group; and
Z² represents —NRa—, wherein Ra represents a hydrogen atom or an alkyl group preferably a hydrogen atom.

Examples of compounds of Formula (MB-α) include:

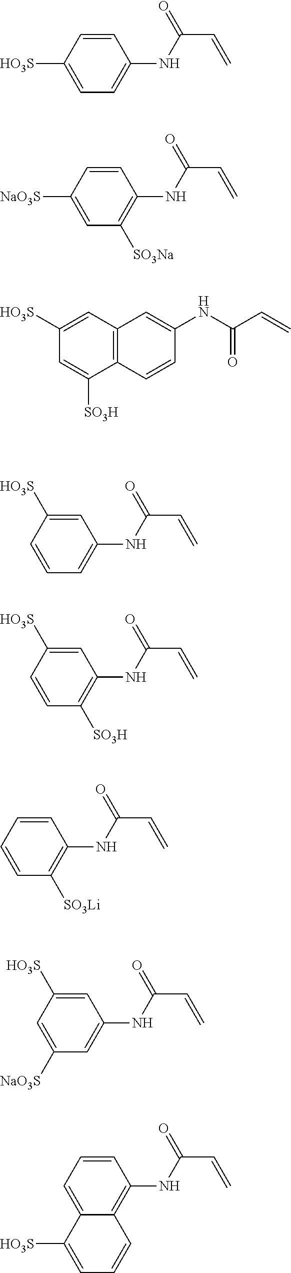

Synthesis methods for compounds of Formula (MB-α) can be found in e.g. US2015/0353696.

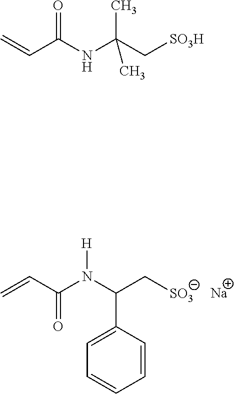

Synthesis methods for the above compounds can be found in e.g. US2016/0369017.

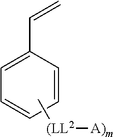

wherein in Formula (AM-B):
LL² represents a single bond or a bivalent linking group; and
A represents a sulfo group in free acid or salt form; and
m represents 1 or 2.

Examples of compounds of Formula (AM-B) include:

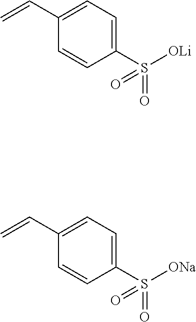

Such compounds of Formula (AM-B) are commercially available, e.g. from Tosoh Chemicals and Sigma-Aldrich.

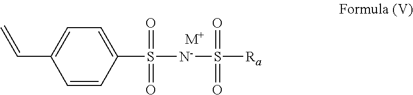

wherein
Rₐ in Formula (V) is C₁₋₄alkyl, NH₂, C₆₋₁₂-aryl; C₁₋₄-perfluoroalkyl; and

M⁺ is a cation, preferably H⁺, Li⁺, Na⁺, K⁺, NL₄⁺ wherein each L independently is H or C₁₋₃-alkyl.

Examples of compounds of Formula (V) include:

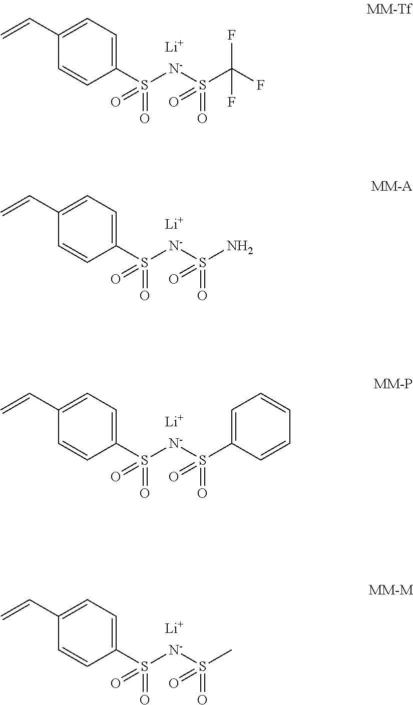

Synthesis methods for the above four compounds having the MM prefix are described in co-pending patent application PCT/EP2022/051934.

Preferably component (c) is chosen from the compounds of Formula (AM-B) and/or Formula (V) because this can result in polymer films having especially good stability in the pH range 0 to 14.

Component (d), a radical initiator, is preferably a thermal initiator or a photoinitiator. Examples of suitable thermal initiators which may be used as component (d) include 2,2′-azobis(2-methylpropionitrile) (AIBN), 4,4′-azobis(4-cyanovaleric acid), 2,2′-azobis(2,4-dimethyl valeronitrile), 2,2′-azobis(2-methylbutyronitrile), 1,1′-azobis(cyclohexane-1-carbonitrile), 2,2′-azobis(4-methoxy-2,4-dimethyl valeronitrile), dimethyl 2,2′-azobis(2-methylpropionate), 2,2′-azobis[N-(2-propenyl)-2-methylpropionamide, 1-[(1-cyano-1-methylethyl)azo]formamide, 2,2′-Azobis(N-butyl-2-methylpropionamide), 2,2′-Azobis(N-cyclohexyl-2-methylpropionamide), 2,2′-Azobis(2-methylpropionamidine) dihydrochloride, 2,2′-Azobis[2-(2-imidazolin-2-yl)propane]dihydrochloride, 2,2′-Azobis[2-(2-imidazolin-2-yl)propane]disulfate dihydrate, 2,2′-Azobis[N-(2-carboxyethyl)-2-methylpropionamidine] hydrate, 2,2′-Azobis{2-[1-(2-hydroxyethyl)-2-imidazolin-2-yl]propane} dihydrochloride, 2,2′-Azobis[2-(2-imidazolin-2-yl)propane], 2,2′-Azobis(1-imino-1-pyrrolidino-2-ethylpropane) dihydrochloride, 2,2′-Azobis{2-methyl-N-[1, 1-bis(hydroxymethyl)-2-hydroxyethl]propionamide} and 2,2′-Azobis[2-methyl-N-(2-hydroxyethyl)propionamide].

Examples of suitable photoinitiators which may be included in the composition as component (d) include aromatic ketones, acylphosphine compounds, aromatic onium salt compounds, organic peroxides, thio compounds, hexa-arylbiimidazole compounds, ketoxime ester compounds, borate compounds, azinium compounds, metallocene compounds, active ester compounds, compounds having a carbon halogen bond, and an alkyl amine compounds. Preferred examples of the aromatic ketones, the acylphosphine oxide compound, and the thio-compound include compounds having a benzophenone skeleton or a thioxanthone skeleton described in “RADIATION CURING IN POLYMER SCIENCE AND TECHNOLOGY”, pp.77-117 (1993). More preferred examples thereof include an alpha-thiobenzophenone compound described in JP1972-6416B (JP-S47-6416B), a benzoin ether compound described in JP1972-3981B (JP-S47-3981B), an alpha-substituted benzoin compound described in JP1972-22326B (JP-S47-22326B), a benzoin derivative described in JP1972-23664B (JP-S47-23664B), an aroylphosphonic acid ester described in JP1982-30704A (JP-S57-30704A), dialkoxybenzophenone described in JP1985-26483B (JP-S60-26483B), benzoin ethers described in JP1985-26403B (JP-S60-26403B) and JP1987-81345A (JPS62-81345A), alpha-amino benzophenones described in JP1989-34242B (JP H01-34242B), U.S. Pat. No. 4,318,791A, and EP0284561A1, p-di(dimethylaminobenzoyl) benzene described in JP1990-211452A (JP-H02-211452A), a thio substituted aromatic ketone described in JP1986-194062A (JPS61-194062A), an acylphosphine sulfide described in JP1990-9597B (JP-H02-9597B), an acylphosphine described in JP1990-9596B (JP-H02-9596B), thioxanthones described in JP1988-61950B (JP-S63-61950B), and coumarins described in JP1984-42864B (JP-S59-42864B). In addition, the photoinitiators described in JP2008-105379A and JP2009-114290A are also preferable. In addition, photoinitiators described in pp. 65 to 148 of “Ultraviolet Curing System” written by Kato Kiyomi (published by Research Center Co., Ltd., 1989) may be used.

Especially preferred photoinitiators include Norrish Type II photoinitiators having an absorption maximum at a wavelength longer than 380 nm, when measured in one or more of the following solvents at a temperature of 23° C.: water, ethanol and toluene. Examples include a xanthene, flavin, curcumin, porphyrin, anthraquinone, phenoxazine, camphorquinone, phenazine, acridine, phenothiazine, xanthone, thioxanthone, thioxanthene, acridone, flavone, coumarin, fluorenone, quinoline, quinolone, naphtaquinone, quinolinone, arylmethane, azo, benzophenone, carotenoid, cyanine, phtalocyanine, dipyrrin, squarine, stilbene, styryl, triazine or anthocyanin-derived photoinitiator.

Preferably component (e) of the composition is an inert solvent. In other words, preferably component (e) does not react with any of the other components of the composition. In one embodiment the component (e) preferably comprises water and optionally an organic solvent, especially where some or all of the organic solvent is water miscible. The water is useful for dissolving component (a) and possibly also component (c) and the organic solvent is useful for dissolving component (b) or any other organic components present in the composition.

Component (e) is useful for reducing the viscosity and/or surface tension of the composition. In some embodiments, the composition comprises 15 to 40 wt %, especially 20 to 30 wt %, of component (e).

Examples of inert solvents which may be used as or in component (e) include water, alcohol-based solvents, ether based solvents, amide-based solvents, ketone-based solvents, sulphoxide-based solvents, sulphone-based solvents, nitrile-based solvents and organic phosphorus based solvents. Examples of alcohol-based solvents which may be used as or in component (e) (especially in combination with water) include methanol, ethanol, isopropanol, n-butanol, ethylene glycol, propylene glycol, diethylene glycol, dipropylene glycol and mixtures comprising two or more thereof. In addition, preferred inert, organic solvents which may be used in component (e) include dimethyl sulphoxide, dimethyl imidazolidinone, sulpholane, N-methylpyrrolidone, dimethyl formamide, acetonitrile, acetone, 1,4-dioxane, 1,3-dioxolane, tetramethyl urea, hexamethyl phosphoramide, hexamethyl phosphorotriamide, pyridine, propionitrile, butanone, cyclohexanone, tetrahydrofuran, tetrahydropyran, 2-methyltetrahydrofuran, ethylene glycol diacetate, cyclopentylmethylether, methylethylketone, ethyl acetate, y-butyrolactone and mixtures comprising two or more thereof. Dimethyl sulphoxide, N-methyl pyrrolidone, dimethyl formamide, dimethyl imidazolidinone, sulpholane, acetone, cyclopentylmethylether, methylethylketone, acetonitrile, tetrahydrofuran, 2-methyltetrahydrofuran and mixtures comprising two or more thereof are preferable. Preferably components (a) and (b) can polymerise by radiation, thermal or electron beam initiation. When component (a) or (b) comprises an ethylenically unsaturated group or thiol group, such group is preferably attached to a benzene ring, e.g. as in divinylbenzene.

Preferably the composition according to the second aspect of the present invention comprises:
(a) 20 to 80 wt % of component (a);
(b) 0.5 to 20 wt % of component (b);
(c) 0 to 40 wt % of component (c);
(d) 0 to 10 wt % of component (d); and
(e) 0 to 40 wt % of component (e).

According to a third aspect of the present invention there is provided a process for preparing the polymer film according to the first aspect of the present invention comprising curing a composition according to the second aspect of the present invention.

The process for preparing the polymer film preferably comprises the steps of:
i. providing a porous support;
ii. impregnating the porous support with the composition of the second aspect of the present invention; and
iii. curing the curable composition.

The preferences for the composition used in the process of the third aspect of the present invention are as described herein in relation to the second aspect of the present invention.

The compositions may be cured by any suitable process, including thermal curing, photo curing, electron beam (EB) irradiation, gamma irradiation, and combinations of the foregoing.

Preferably the process according to the third aspect of the present invention comprises a first curing step and a second curing step (dual curing). In a preferred embodiment the compositions are cured first by photo curing, e.g. by irradiating the compositions by ultraviolet or visible light, or by gamma or electron beam radiation, and thereby causing the curable components present in the compositions to polymerise, and then applying a second curing step. The second curing step preferably comprises thermal curing, gamma irradiation or EB irradiation whereby the second curing step preferably applies a different method than the first curing step. When gamma or electron beam irradiation is used in the first curing step preferably a dose of 60 to 120 kGy, more preferably a dose of 80 to 100 kGy.

In one embodiment the process according to the third aspect of the present invention comprises curing the composition in the first curing step to form the polymer film, winding the polymer film onto a core, optionally together with an inert polymer foil, and then performing the second curing step.

In a preferred embodiment the first and second curing steps are respectively selected from (i) UV curing then thermal curing; (ii) UV curing then electron beam curing; and (iii) electron beam curing then thermal curing.

The composition preferably comprises 0.05 to 5 wt % of component (d) for the first curing step. The composition optionally further comprises 0 to 5 wt % of a second component (d) for the second curing step. When it is intended to cure the composition thermally or using light (e.g. UV or visible light) the composition preferably comprises 0.001 to 2 wt %, depending on the selected radical initiator, in some embodiments 0.005 to 0.9 wt %, of component (d). Component (d) may comprise more than one radical initiator, e.g. a mixture of several photoinitiators (for single curing) or a mixture of photoinitiators and thermal initiators (for dual curing). Alternatively a second curing step is performed using gamma or EB irradiation. For the second curing step by gamma or EB irradiation preferably a dose of 20 to 100 kGy is applied, more preferably a dose of 40 to 80 kGy.

For the optional second curing step, thermal curing is preferred. The thermal curing is preferably performed at a temperature between 50 and 100° C., more preferably between 60 and 90° C. The thermal curing is preferably performed for a period between 2 and 48 hours, e.g. between 8 and 16 hours, e.g. about 10 hours. Optionally after the first curing step a polymer foil is applied to the polymer film before winding (this reduces oxygen inhibition and/or sticking of the polymer film onto itself).

Preferably the process according to the third aspect of the present invention is performed in the presence of a porous support. For example, the composition according to the second aspect of the present invention is present in and/or on a porous support. The porous support provides mechanical strength to the polymer film resulting from curing the composition according to the second aspect of the present invention and this is particularly useful when the polymer film is intended for use as a CEM or BPM.

As examples of porous supports which may be used there may be mentioned woven and non-woven synthetic fabrics and extruded films. Examples include wetlaid and drylaid non-woven material, spunbond and meltblown fabrics and nanofiber webs made from, e.g. polyethylene, polypropylene, polyacrylonitrile, polyvinyl chloride, polyphenylenesulfide, polyester, polyamide, polyaryletherketones such as polyether ether ketone and copolymers thereof. Porous supports may also be porous membranes, e.g. polysulphone, polyethersulphone, polyphenylenesulphone, polyphenylenesulfide, polyimide, polyethermide, polyamide, polyamideimide, polyacrylonitrile, polycarbonate, polyacrylate, cellulose acetate, polypropylene, poly(4-methyl 1-pentene), polyinylidene fluoride, polytetrafluoroethylene, polyhexafluoropropylene and polychlorotrifluoroethylene membranes and derivatives thereof.

The porous support preferably has an average thickness of between 10 and 800 μm, more preferably between 15 and 300 μm, especially between 20 and 150 μm, more especially between 30 and 130 μm, e.g. around 60 μm or around 100 μm.

Preferably the porous support has a porosity of 30 and 95%. The porosity of the support may be determined by a porometer, e.g. a Porolux™ 1000 from IB-FT GmbH, Germany.

The porous support, when present, may be treated to modify its surface energy, e.g. to values above 45 mN/m, preferably above 55 mN/m. Suitable treatments include corona discharge treatment, plasma glow discharge treatment, flame treatment, ultraviolet light irradiation treatment, chemical treatment or the like, e.g. for the purpose of improving the wettability of and the adhesiveness to the porous support to the polymer film.

Commercially available porous supports are available from a number of sources, e.g. from Freudenberg Filtration Technologies (Novatexx materials), Lydall Performance Materials, Celgard LLC, APorous Inc., SWM (Conwed Plastics, DelStar Technologies), Teijin, Hirose, Mitsubishi Paper Mills Ltd and Sefar AG.

Preferably the porous support is a porous polymeric support. Preferably the porous support is a woven or non-woven synthetic fabric or an extruded film without covalently bound ionic groups.

In a preferred process according to the third aspect of the present invention, the composition according to the second aspect of the present invention may be applied continuously to a moving (porous) support, preferably by means of a manufacturing unit comprising a composition application station, one or more irradiation source(s) for curing the composition, a polymer film collecting station and a means for moving the support from the composition application station to the irradiation source(s) and to the polymer film collecting station.

The composition application station may be located at an upstream position relative to the irradiation source(s) and the irradiation source(s) is/are located at an upstream position relative to the polymer film collecting station.

Examples of suitable coating techniques for applying the composition according to the second aspect of the present invention to a porous support include slot die coating, slide coating, air knife coating, roller coating, screen-printing, and dipping. Depending on the used technique and the desired end specifications, it might be desirable to remove excess coating from the substrate by, for example, roll-to-roll squeeze, roll-to-blade or blade-to-roll squeeze, blade-to-blade squeeze or removal using coating bars. Curing by light is preferably done for the first curing step, preferably at a wavelength between 300 nm and 800 nm using a dose between 40 and 20000 mJ/cm². In some cases additional drying might be needed for which temperatures between 40° C. and 200° C. could be employed. When gamma or EB curing is used irradiation may take place under low oxygen conditions, e.g. below 200 ppm oxygen.

Preferably the polymer film is a cation exchange membrane (CEM) or a cation exchange layer (CEL) forming a part of a bipolar membrane (BPM) obtained from polymerising the composition according to the second aspect of the present invention, and/or by a process according to the third aspect of the present invention. Preferably the BPM further comprises an anion exchange layer (AEL).

According to a fourth aspect of the present invention there is provided a bipolar membrane (BPM) comprising the polymer film according to the first aspect of the present invention.

The process according to the third aspect of the present invention may be used to prepare BPMs according to the fourth aspect of the present invention in several ways, including multi-pass and single-pass processes. For example, in a two-pass process, each of the two BPM layers (the CEL and AEL) may be produced in separate steps. In the first step to make a first layer, an optionally pre-treated porous support may be impregnated with a first composition. To ensure a thin and pinhole-free membrane, the coating step is preferably followed by squeezing. The impregnated support may then be cured, yielding a layer hard enough to be handled in the coating machine, but still containing enough unreacted polymerisable groups to ensure good adhesion to the second layer. In the second step, a very similar process as for the first layer is employed: an optionally pre-treated porous support may be impregnated with a second composition and laminated to the first layer followed by squeezing-off excess composition and curing. Preferably one of the first and the second composition is the composition according to the second aspect of the present invention.

In an alternative method for making a BPM, the second layer may be coated on the first layer, followed by laminating an optionally pre-treated porous support at the side of the second composition whereby the second composition impregnates the porous support. The resulting laminate may be squeezed and cured to yield the composite membrane.

If the first composition applied in this process is the cation exchange layer (CEL), the optionally present polymer foil is removed before laminating the CEL with the anion exchange layer (AEL) and then optionally reapplied before performing the second curing step, e.g. when thermal curing is applied as second curing step.

In a more preferred single-pass process for preparing a BPM, two optionally pre-treated porous supports are unwound and each is impregnated with a composition simultaneously, wherein one of the compositions is as defined in the second aspect of the present invention to give a CEL, and the other composition comprises at least one cationic curable monomer to provide an AEL. The two layers (CEL from the composition according to the second aspect of the present invention and the AEL from the other composition) are then laminated together and squeezed, followed by curing of the resulting laminate to yield the BPM. Optionally, subsequently a second curing step is applied as described above.

The efficiency of the BPM according to the fourth aspect of the present invention may be enhanced by enlarging the surface area between the AEL and the CEL, e.g. by physical treatment (roughening) or by other means.

In one embodiment, the BPM according to the fourth aspect of the present invention optionally comprises a catalyst, e.g. metal salts, metal oxides, organometallic compounds, monomers, polymers or co-polymers or salt, preferably at the interface of the BPM's CEL and AEL.

Suitable inorganic compounds or salts which may be used as a catalyst include cations selected from, for example, group 1a through to group 4a, inclusive, together with the lanthanides and actinides, in the periodic table of elements, for example thorium, zirconium, iron, lanthanum, cobalt, cadmium, manganese, cerium, molybdenum, nickel, copper, chromium, ruthenium, rhodium, tin, titanium and indium. Suitable salts which may be used as a catalyst include anions such as tetraborate, metaborate, silicate, metasilicate, tungstate, chlorate, chloride, phosphate, sulfate, chromate, hydroxyl, carbonate, molybdate, chloroplatinate, chloropaladite, orthovandate, tellurate and others, or mixtures of the above.

Other examples of inorganic compounds or salts which may be used as a catalyst include, but are not limited to, FeCl₃, FeCl₂, AlCl₃, MgCl₂, RuCl₃, CrCl₃, Fe(OH)₃, Al₂O₃, NiO, Zr(HPO₄)₂, MoS₂, graphene oxide, Fe-polyvinyl alcohol complexes, polyvinyl alcohol (PVA), polyethylene glycol (PEG), polyethyleneimine (PEI), polyacrylic acid (PAA), co-polymer of acrylic acid and maleic anhydride (PAAMA) and hyperbranched aliphatic polyester.

The CEM according the present invention preferably has a very high density as a result of preparing the CEM from a composition according to the second aspect of the present invention having a low amount of component (e) Thus the present invention enables the production of polymer films (e.g. CEMs and BPMs) having a very high ion exchange capacity and therefore low electrical resistance.

The CEMs and the BPMs containing a cationic exchange layer (CEL) according to the present invention have good pH stability and low electrical resistance. As a result, the CEMs and BPMs according to the present invention can be used in bipolar electrodialysis to provide high voltages at low current densities. Thus when the BPMs of the present invention are used in bipolar electrodialysis processes for the production of acid and base they can provide low energy costs and/or high productivity.

According to a fifth aspect of the present invention there is provided use of the cation exchange membrane and/or the bipolar membrane according to present invention for the treatment of polar liquids, e.g. desalination, for the production the acids and bases or for the generation of electricity.

### EXAMPLES

In the following non-limiting examples all parts and amounts are by weight unless specified otherwise.

XL-B and MM-P are synthesized in the laboratory according the procedures below.

### Synthesis of MM-P and XL-B CI-SS

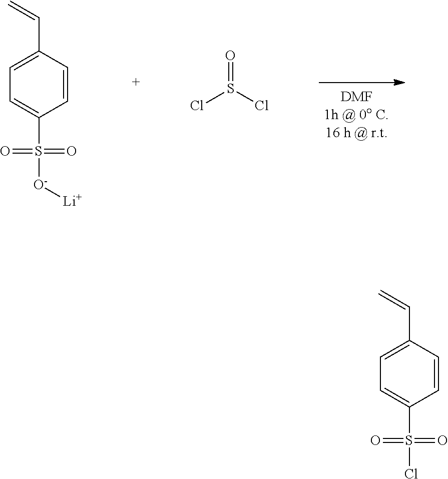

Thionyl chloride (109 mL, 178.46 g, 1.5 mol, 3 moleq) was added dropwise to a solution of 4-vinylbenzenesulfonic acid lithium salt (95.08 g, 0.500 mol, 1 moleq) and 4OH-TEMPO (50 mg, 500 ppm) in DMF (300 mL) in a double-walled reactor that was actively cooled to 5° C. After the addition was completed, the solution was allowed to slowly heat to room temperature and was stirred for another 16 hours. Then the reaction mixture was poured into 1 litre of cold 1M KCI in a separation funnel. The bottom layer was removed and dissolved in 500 mL diethylether. This solution was washed with a 1M KCI-solution (300 mL). The organic layer was dried over sodium sulfate, filtered and concentrated in vacuum to give a yellow oil. The crude product was used without further purification in the next step. Typical yield is 89.5 g (88%). HPLC-MS purity>98%; ¹H-NMR: <2 wt % DMF, 0% diethyl ether.

### NH2-SS

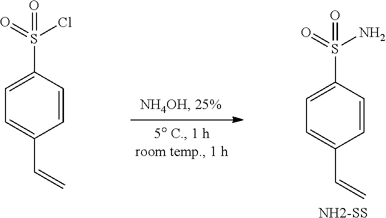

Thionyl chloride (109 mL, 178.46 g, 1.5 mol, 3 moleq) was added dropwise to a solution of 4-vinylbenzene sulfonic acid lithium salt (95.08 g, 0.500 mol, 1 moleq) and 4OH-TEMPO (50 mg, 500 ppm) in DMF (300 mL) in a double-walled reactor that was actively cooled to 5° C. After the addition was completed, the solution was allowed to slowly heat to room temperature and was stirred for another 16 hours. Then the reaction mixture was poured into 1 litre of cold 1M KCI in a separation funnel. The bottom layer was removed and was added dropwise to a solution of ammonium hydroxide 25% in water (250 ml, 3.67 mol, 15 moleq) and 4OH-TEMPO (50 mg, 500 ppm) in a double-walled reactor that was actively cooled to 5° C. After the addition was completed, the solution was stirred for 1 hour. The solution was then allowed to heat to room temperature and was stirred for one hour. Then the reaction mixture was cooled back to 5° C. and the product was filtered off and washed with 50 mL of cold water. The product was dried overnight in vacuum at 30° C. and used without further purification. Typical yield was 66.8 g (73%). HPLC-MS purity>95%.

### Preparation of XL-B

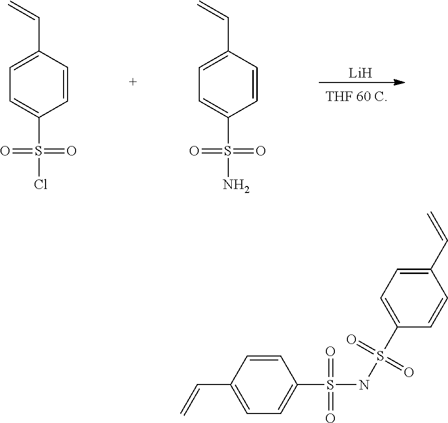

Before the synthesis, vinyl benzene sulphonamide was dried in a vacuum oven overnight (30° C., vac). To a solution of the dried vinyl benzene sulphonamide (11.12 g, 0.061 mol, 1 moleq) and 4OH-TEMPO (30 mg, 500 ppm) in THF (100 mL) was added LiH (1.06 g, 0.134 mol, 2.2 moleq) as a solid at once. The reaction mixture was stirred for 30 minutes at room temperature. Then, a solution of CI-SS (12.3 g, 0.061 mol, 1 moleq) in THF (50 mL) was added to the reaction mixture. After addition, the reaction mixture was heated to 60° C. (water bath temperature). After two days, the reaction mixture was filtrated over celite to remove the excess of LiH. Celite was added and the resulting slurry was stirred for 5 minutes. Then, the celite was filtered off and washed with 100 mL ethyl acetate. The solvent was then evaporated in vacuo and the resulting white foam was washed with 500 mL diethyl ether overnight. The resulting white powder was filtered off and dried in a vacuum oven at 30° C. for 16 h yielding a white solid. Typical yield is 11 g (51%). HPLC-MS purity>94%; ¹H-NMR : <1 wt % residual solvents, <5 wt % styrene sulphonate or styrene sulphonamide; ICP-OES: 18-22 g Li/kg product.

### Preparation of MM-P

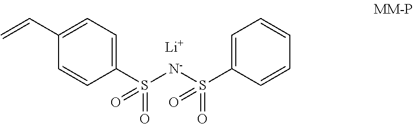 [SMILES: C=Cc1ccc(S(=O)(=O)[N-]S(=O)(=O)c2ccccc2)cc1 ; [Li+]]

Before the synthesis, benzenesulphonamide was dried in a vacuum oven overnight at 30° C. To a solution of the dried benzenesulphonamide (0.100 mol, 1 moleq) and 4OH-TEMPO (30 mg, 500 ppm) in THF (100 mL) was added LiH (0.300 mol, 3 moleq) as a solid at once. The reaction mixture was stirred for 30 minutes at room temperature. Then, a solution of vinyl benzene sulphonyl chloride (CI-SS, 0.100 mol, 1 moleq) in THF (50 mL) was added and the reaction mixture was heated to 60° C. (water bath temperature) for 16 h. The resulting solution was filtrated over celite and the resulting foam was dissolved in 500 mL ethyl acetate. Celite was added and the resulting slurry was stirred for 5 minutes. Then, the celite was filtered off and washed with 100 mL ethyl acetate. The solvent was then evaporated in vacuum and the resulting white foam was crushed with 500 mL diethyl ether overnight. The resultant compound MM-P was collected by filtration and isolated as a white hygroscopic powder. Yield was 79%, purity>96%, residual solvents<1%, residual LiSS<2% and Li content between 23-28 mg/kg.

TABLE 1
Ingredients used in the Examples:

| | Component | |
|---|---|---|
| Abbreviation | Type | Description/supplier |
| XL-B | (a) | Benzenesulfonamide, 4-ethenyl-N-[(4- |
| | | ethenylphenyl)sulfonyl]-, lithium salt |
| LiSS | | Styrene sulfonate, lithium salt from Tosoh chemicals |
| Cl-SS | | Styrene sulfonate, chloride |
| NH2-SS | | Styrene sulfonamide |
| Benzene | | From Sigma-Aldrich |
| suphonamide | | |
| PBD-SA | (b) | Polybutadiene, predominantly 1,2-adition from Sigma- |
| | | Aldrich |
| Ricon ® 100 | (b) | Polybutadiene from Cray Valley |
| Ricon ® 152 | (b) | Polybutadiene from Cray Valley |
| Ricon ® 130 CF | (b) | Polybutadiene from Cray Valley |
| Ricon ® 131 | (b) | Polybutadiene from Cray Valley |
| Ricon ® 156 | (b) | Polybutadiene from Cray Valley |
| B-1000 | (b) | Polybutadiene from Nippon Soda Co. |
| B-2000 | (b) | Polybutadiene from Nippon Soda Co |
| Poly BD | (b) | Polybutadiene from Cray Valley |
| R45HTLO | | |
| Krasol ® LBH | (b) | Polybutadiene from Cray Valley |
| P3000 CF | | |
| Krasol ® LBH- | (b) | Polybutadiene from Cray Valley |
| P2000 CF | | |
| MM-P | (c) | Benzenesulfonamide, 4-ethenyl-N-(phenylsulfonyl)-, |
| | | lithium salt |
| MeOH | (e) | Methanol, from Sigma-Aldrich |
| IPA | | Isopropanol from Sigma-Aldrich |
| THF | | Tetrahydrofuran from Sigma-Aldrich |
| DMF | | Dimethylformamide from Sigma-Aldrich |
| DCM | | Dichloromethane from Sigma-Aldrich |
| MCH | | Methylcyclohexane from Sigma-Aldrich |
| NMP | | N-methylpyrrole from Sigma-Aldrich |
| DMSO | | Dimethylsulfoxide from Sigma-Aldrich |
| 1-methoxy-2- | (e) | From Sigma-Aldrich |
| propanol | | |
| PW | (e) | Purified water |
| TFA | | Trifluoroacetic acid from Sigma-Aldrich |
| KCl | | Potassium chloride from Sigma-Aldrich |
| LiH | | Lithium hydride from Sigma-Aldrich |
| Celite | | Celite S, diatomaceous earth (SiO₂) from Sigma- |
| | | Aldrich |
| 4OH-TEMPO | | 4-hydroxy-2,2,6,6-tetramethylpiperidin-1-oxyl, from |
| | | Evonik |
| LAP | (d) | phenyl-2,4,6-trimethylbenzoylphosphinate, lithium salt |
| | | from Ambeed |
| TPO-L | (d) | (ethyl(2,4,6-trimethylbenzoyl)-phenyl phosphinate from |
| | | IGM resin |
| V-59 | (d) | 2,2′-Azobis(2-methylbutyronitrile) from Fujifilm-Wako |
| | | Chemicals |
| Non-woven | support | PP/PE 26 gsm and 80 μm thick |

### Preparation of the Examples

Polymer films (cation exchange membranes) according to the first aspect of the present invention and the Comparative Example were prepared by applying each of the compositions described in Table 2 onto a nonwoven porous support made from PP/PE coextruded fibers with a weight of 26 gram per square meter and a thickness of 80 μm using a 4 μm Meyer bar and then curing the composition by UV curing by placing the samples on a conveyor at 5 m/min equipped with a D-bulb in a Light Hammer® 10 of Fusion UV Systems Inc. at 40% intensity followed by thermal curing at 90° C. for 3 hours as second curing step. The thermal curing was performed with a foil laminated on top of the coating to avoid evaporation of the solvents and exposure to oxygen. This formed a polymer film (including the porous support) of thickness 80 μm.

The PS and ER of the resultant polymer films were measured as described below and the results are shown in Table 2 below.

TABLE 2
Curable compositions and results of prepared CEMs

| Ingredients (wt %) | Ex. 1 | Ex. 2 | Ex. 3 | Ex. 4 | Ex. 5 | Ex. 6 | Ex. 7 | Ex. 8 |
|---|---|---|---|---|---|---|---|---|
| PW | 18.7 | 18.7 | 18.7 | 18.7 | 18.7 | 18.7 | 18.7 | 18.7 |
| 1-methoxy-2- | 5.3 | 5.3 | 5.3 | 5.3 | 5.3 | 5.3 | 5.3 | 5.3 |
| propanol | | | | | | | | |
| Ricon 100 | 12.5 | | | | | | | |
| Ricon 152 | | 12.5 | | | | | | |
| Ricon 130 CF | | | 12.5 | | | | | |
| Ricon 131 | | | | 12.5 | | | | |
| Ricon 156 | | | | | 12.5 | | | |
| B-1000 | | | | | | 12.5 | | |
| B-2000 | | | | | | | 12.5 | |
| Poly BD R45HTLO | | | | | | | | 12.5 |
| 4OH-TEMPO | 1 | 1 | 1 | 1 | 1 | 1 | 1 | 1 |
| (2% in Water) | | | | | | | | |
| V-59 | 1 | 1 | 1 | 1 | 1 | 1 | 1 | 1 |
| TPO-L | 0.5 | 0.5 | 0.5 | 0.5 | 0.5 | 0.5 | 0.5 | 0.5 |
| LAP | 0.5 | 0.5 | 0.5 | 0.5 | 0.5 | 0.5 | 0.5 | 0.5 |
| XL-B | 60.8 | 60.8 | 60.8 | 60.8 | 60.8 | 60.8 | 60.8 | 60.8 |
| TOTAL (wt %) | 100 | 100 | 100 | 100 | 100 | 100 | 100 | 100 |
| PS 0.05-0.5M | 70.1 | 76.2 | 86.4 | 82 | 81.9 | 83.8 | 70.0 | 70.6 |
| NaOH (%) | | | | | | | | |
| ER 0.5M NaCl | 2.5 | 2.3 | 3.3 | 3.0 | 2.4 | 2.8 | 1.9 | 2.8 |
| (ohm · cm²) | | | | | | | | |

| Ingredients (wt %) | Ex. 9 | Ex.10 | Ex. 11 | Ex. 12 | Ex. 13 | CEx. 1 |
|---|---|---|---|---|---|---|
| PW | 18.7 | 18.7 | 17.2 | 17.2 | 17.2 | 21.4 |
| 1-methoxy-2-propanol | 5.3 | 5.3 | | | | 6.1 |
| MeOH | | | 8 | 5.4 | 0.2 | |
| Krasol LBH P3000 CF | 12.5 | | | | | |
| Krasol LBH-P2000 CF | | 12.5 | | | | |
| PBD-SA, predominantly | | | 2.6 | 5.2 | 10.4 | |
| 1,2-addtion | | | | | | |
| 4OH-TEMPO (2% in Water) | 1 | 1 | 1 | 1 | 1 | 1 |
| V-59 | 1 | 1 | 1 | 1 | 1 | 1 |
| TPO-L | 0.5 | 0.5 | 0.5 | 0.5 | 0.5 | 0.5 |
| LAP | 0.5 | 0.5 | 0.5 | 0.5 | 0.5 | 0.5 |
| MM-P | | | 12.9 | 12.9 | 12.9 | |
| XL-B | 60.8 | 60.8 | 56.3 | 56.3 | 56.3 | 69.5 |
| TOTAL | 100 | 100 | 100 | 100 | 100 | 100 |
| PS 0.05-0.5M NaOH | 77.6 | 89.0 | 79.7 | 73.0 | 70.2 | 56.4 |
| (%) | | | | | | |
| ER 0.5M NaCl | 2.1 | 4.4 | 2.0 | 1.5 | 1.6 | 1.8 |
| (ohm · cm²) | | | | | | |

### Methods

### Measurement of Electrical Resistance (ER)

ER (ohm.cm²) of the polymer films prepared in the Examples was measured by the method described by Dlugolecki et al., J. of Membrane Science, 319 (2008) on page 217-218 with the following modifications:
the auxiliary polymer films were CMX and AMX from Tokuyama Soda, Japan;
the capillaries as well as the Ag/AgCl references electrodes (Metrohm type 6.0750.100) contained 3M KCI;
the calibration liquid and the liquid in compartment 2, 3, 4 and 5 was 0.5 M NaCl solution at 25° C.;
the effective polymer film area was 9.62 cm²;
the distance between the capillaries was 5.0 mm;
the measuring temperature was 25° C.;
a Cole Parmer Masterflex console drive (77521-47) with easy load II model 77200-62 gear pumps was used for all compartments;
the flowrate of each stream was 475 ml/min controlled by Porter Instrument flowmeters (type 150AV-B250-4RVS) and Cole Parmer flowmeters (type G-30217-90); and
the samples were equilibrated for at least 1 hour at room temperature in a 0.5 M solution of NaCl prior to measurement.

### Measurement of Permselectivity (PS)

The permselectivity PS (%) that is the selectivity to the passage of ions of opposite charge to that of the polymer films prepared in the examples, was measured as follows. The polymer film to be analyzed was placed in a two-compartment system. One compartment is filled with a 0.05M solution of NaOH and the other with a 0.5M solution of NaOH.

### Settings

### the capillaries as well as the Ag/AgCl reference electrodes (Metrohm type 6.0750.100) contained 3M KCI;

the effective polymer film area was 9.62 cm²;
the distance between the capillaries was ca 15 mm;
the measuring temperature was 21.0±0.2° C.;
a Cole Parmer Masterflex console drive (77521-47) with easy load II model 77200-62 gear pumps was used for the two compartments;
Porter Instrument flowmeters (type 150AV-B250-4RVS) and Cole Parmer flowmeters (type G-30217-90) were used to control the flow constant at 500 ml/min;
The samples were equilibrated for 1 hr in a 0.5 M NaOH solution prior to measurement. The voltage was read from a regular VOM (multitester) after 20 minutes.

Preferably the PS for NaOH is at least 70%.

1. A polymer film obtainable from curing a composition comprising:
(a) a curable ionic compound comprising a bis(sulfonyl)imide group; and
(b) a curable non-ionic compound comprising at least 4 vinyl groups.

2. A polymer film according to claim 1 wherein component (b) is a curable non-ionic compound of Formula (I);
R′—Aₙ—Bₘ—C_{q}—R′ Formula (I)
wherein:
A is [CH₂CH═CHCH₂];
B is [CH₂CH(CH═CH₂)];
C is [CH₂CH(C₆H₅)];
n has a value of from 5 to 85% of the sum of (n+m+q);
m has a value of from 15 to 95% of the sum of (n+m+q);
q has a value of from 0 to 30% of the sum of (n+m+q); and
each R′ independently is H or OH; provided that the non-ionic compound of Formula (I) comprises at least 4 vinyl groups.

3. The polymer film according to claim 1 wherein component (a) is a curable ionic compound of Formula (II): 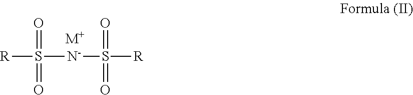
wherein:
each R independently comprises a polymerisable or non-polymerisable group; and M⁺ is a cation.

4. The polymer film according to claim 3 wherein each R independently comprises a group selected from vinyl, allyl, alkylenethiol, arylenevinyl, arylenedivinyl, arylene-alkylenethiol, arylene-dialkylenethiol, C₁₋₆ alkyl and C₆-C₁₈ aryl, provided that the compound of Formula (II) comprises at least two polymerisable groups.

5. The polymer film according to claim 1 wherein the component (b) has a melting temperature below 50° C.

6. The polymer film according to claim 1 wherein component (b) has a viscosity of less than 600 Poise at 40° C.

7. The polymer film according to claim 1 wherein component (a) is of Formula (III): 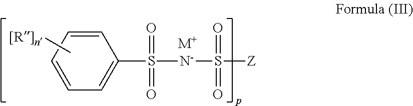
wherein:
each R″ independently is a polymerisable or non-polymerisable group;
n′ has a value of 1 or 2;
p has a value of 1, 2 or 3;
M⁺ is a cation; and
Z is N or a linking group;
provided that the compound of Formula (III) comprises at least two polymerisable groups.

8. The polymer film according to claim 7 wherein n′ and p both have a value of 1, R″ is a vinyl group and Z is a phenylene group carrying a vinyl group.

9. The polymer film according to claim 7 wherein p has a value of 2 or 3 and Z is C₁₋₆-alkylene, C₁₋₆ perfluoroalkylene, C₆₋₁₈-arylene group or a group of the formula N(R″′)₍₃₋ₚ₎ wherein each R″′ independently is H or C₁₋₄-alkyl.

10. The polymer film according to claim 7 wherein p has a value of 1, n′ has a value of 2 and Z is a C₁₋₆-alkyl, C₁₋₆-perfluoroalkyl, C₆₋₁₈-aryl group or a group of the formula N(R″′)₂ wherein each R″′ independently is H or C₁₋₄-alkyl.

11. The polymer film according to claim 1 wherein components (a) and (b) are copolymerisable.

12. The polymer film according to claim 1 wherein the composition comprises 20 to 80 wt % of component (a) and 0.5 to 20 wt % of component (b).

13. The polymer film according to claim 1 wherein the composition optionally further comprises one or more of the following components:
(c) a compound comprising one and only one polymerisable group;
(d) one or more radical initiators; and
(e) solvent.

14. A composition comprising:
(a) a curable ionic compound comprising a bis(sulfonyl)imide group;
(b) a curable non-ionic compound comprising at least 4 vinyl groups;
optionally (c) a compound comprising one and only one polymerisable group;
optionally (d) one or more radical initiators; and
optionally (e) solvent.

15. A process for preparing a polymer film comprising the steps of:
(i) providing a porous support;
(ii) impregnating the porous support with a composition according to claim 14; and
(iii) curing the composition.

16. The process according to claim 15 wherein the curing comprises a first curing step and a second curing step.

17. The process according to claim 16 wherein the first and second curing steps are respectively selected from (i) UV curing then thermal curing; (ii) UV curing then electron beam curing; and (iii) electron beam curing then thermal curing.

18. The process according to claim 16 which comprises curing the composition in the first curing step to form a polymer film, winding the polymer film onto a core, optionally together with an inert polymer foil, and then performing the second curing step.

19. A cation exchange membrane comprising the polymer film according to claim 1.

20. A bipolar membrane comprising the polymer film according to claim 1.

21. A method of using the cation exchange membrane according to claim 19 for the treatment of polar liquids, for the production of acids and bases or for the generation of electricity.

22. The polymer film according to claim 1 wherein the component (b) has a molecular weight of at least 600 g/mol and a number average molecular weight (Mn) not higher than 15,000 Da.

23. The polymer film according to claim 1 wherein the component (b) has a melting temperature below 50° C., a viscosity of less than 600 Poise at 40° C., and a number average molecular weight (Mn) not higher than 15,000 Da.

24. The polymer film according to claim 2 wherein the component (b) has a melting temperature below 50° C., a viscosity of less than 600 Poise at 40° C., and a number average molecular weight (Mn) not higher than 15,000 Da.

25. The polymer film according to claim 3 wherein the component (a) comprises at least two polymerisable groups comprising ethylenically unsaturated groups, preferably vinyl groups, or thiol groups.

26. The polymer film according to claim 25 wherein the component (b) has a melting temperature below 50° C., a viscosity of less than 600 Poise at 40° C., and a number average molecular weight (Mn) not higher than 15,000 Da.

27. A method of using the bipolar membrane according to claim 20 for the treatment of polar liquids, for the production of acids and bases or for the generation of electricity.

28. The polymer film according to claim 3 wherein the component (a) comprises vinyl groups, or thiol groups.
